(19) United States
(12) Patent Application Publication
(10) Pub. No.: US 2009/0042501 A1
(43) Pub. Date: Feb. 12, 2009

(54) Localized Air Distribution System

(76) Inventor: Stephen T. Hung, Grosse Pointe Park, MI (US)

Correspondence Address: VISTEON/BRINKS HOFER GILSON & LIONE, 524 South Main Street, Suite 200, Ann Arbor, MI, 48104, US

(21) Appl. No.: 11/834,755

(22) Filed: Aug. 7, 2007

(51) Int. Cl. B60N 2/56

(52) U.S. Cl. 454/120

(57) ABSTRACT

Provided is an air distribution system for use in a passenger compartment of a motor vehicle. The air distribution system has a conduit in fluid communication with an HVAC system. The conduit has an outlet that is located under a vehicle seat, and which transfers conditioned air from the HVAC system through the conduit and which discharges the conditioned air generally under the seat in such a manner that the conditioned air flows out from under the vehicle seat and up along a side of the seat. The outlet may also, or in the alternative, be configured to specifically direct conditioned air upward along a side of the vehicle seat.

### BACKGROUND

1. Field of the Invention

The present invention generally relates to a climate control system of a motor vehicle. More specifically, the invention relates to air distribution sub-systems of such climate control systems.

2. Description of Related Art

Current climate control systems within motor vehicles take various forms, including registers that direct air toward the vehicle occupants, in-seat heaters and coolers, and thermoelectric devices that heat or cool air under a vehicle seat.

Traditional air registers direct narrow air flows through the vehicle's cabin toward the occupants. This air flow reaches only a small portion of the occupants' bodies, and the occupants typically choose whether to direct the air toward their feet, lap, torso, or head. If an occupant places her hands in front, of a register to heat or cool her hands, climatized air will be blocked from reaching the rest of her body. Air registers located in the instrument panel require velocities large enough to carry the air from the instrument panel to the occupant. This typically creates a blowing noise that is easily heard because the instrument panel registers are typically located at the occupant's ear level. Another problem with traditional climate control systems is that if cooling is being used the engine typically must be running to run the air conditioning compressor.

In-seat heaters and coolers have also been used to provide comfort to the occupants of vehicles. For example, Amerigon Corp., having headquarters in Northville, Mich. USA, produces a seat having a climate control system provided therein. In this system, a fan takes in air under the seat, which is then, heated or cooled using thermoelectric, technology, and subsequently distributed to the occupant through the seat. As another example,; W.E.T. Automotive Systems AG, of Odelzhausen, Germany, produces a system that includes a fan which takes air from the vehicle's interior and redirects the air through a network of ducts traveling through heat mats to the surface of the seat. The cooling system draws warm air and moisture from the seat into an air bag located in the seat. Both of these systems operate to cool only the region of the occupant's body that remains in contact with the vehicle seat. In addition, these systems are somewhat inefficient as they operate to heat or cool passenger-compartment air using a separate system located within the vehicle seat.

### SUMMARY

In overcoming the enumerated drawbacks and other limitations of the related art, the present invention provides a climate control system for use in a motor vehicle that efficiently cools a passenger's body, while keeping energy consumption and noise to a minimum.

In one aspect, the present invention provides an air distribution system for use in a passenger compartment of a motor vehicle. The air distribution system has a conduit with an intake end and a discharge end, the intake end being in fluid communication with a conventional climate control or heating ventilating, and air conditioning (HVAC) system. Preferably, at least a portion of the conduit is located within a center console to be installed in a vehicle. In fluid communication with the discharge end of the conduit is an outlet. The conduit transfers conditioned or climatized air from the vehicle's HVAC system to the outlet, which discharges the conditioned air under the vehicle seat so as to allow the conditioned air to flow out from under the vehicle seat, along one or both sides of the seat.

In another aspect of the invention, an air distribution system may include a plenum or plenum system in conjunction with the conduit. The plenum or plenum, which is located beneath or inside the vehicle seat, is in fluid communication with the discharge end of the conduit and is receives and distributes, via its outlet, conditioned air upward from the plenum on at least one side of the vehicle seat.

In another aspect, an air distribution system is provided in which the conduit is in fluid communication with an outlet incorporated within a lower seat belt anchor. The outlet, being incorporated with the lower seat belt anchor, is connected to the discharge end of the conduit and directs the conditioned air upward.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a partial perspective view of a passenger compartment of a motor vehicle, having a portion of a seat cut away, incorporating an air distribution system embodying the principles of the present invention;

FIG. 2 is a partial perspective view of a passenger compartment of a motor vehicle incorporating another air distribution system embodying the principles of the present invention;

FIG. 3 is a partial perspective view of a passenger compartment of a motor vehicle incorporating, yet, another air distribution system embodying the principles of the present invention;

FIG. 4 is a partial perspective view of a passenger compartment of a motor vehicle incorporating still another air distribution system embodying the principles of the present invention;

FIG. 5 is a partial perspective view of a passenger, compartment of a motor vehicle incorporating still another air distribution system embodying the principles of the present invention and including an outlet incorporated into a lower seat belt anchor; and

FIG. 5A is a close-up perspective view of the outlet and seat belt anchor of FIG. 5.

### DETAILED DESCRIPTION

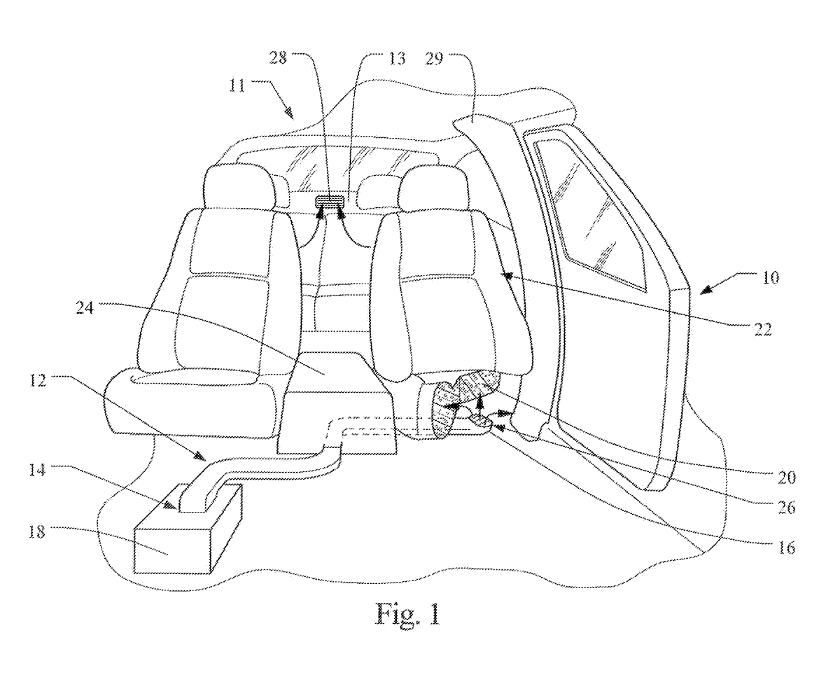

Referring now to FIG. 1, one form of an air distribution system embodying the principles of the present invention is illustrated therein and designated at 10. The air distribution system 10 is installed in a passenger compartment of a motor vehicle 11 and includes a conduit 12, which has an intake end 14 and a discharge end 16. The intake end 14 is connected to and in fluid communication with the vehicle's heating, ventilation, and air conditioning (HVAC) system, which is schematically represented at 18. The intake end 14 receives conditioned air (heated, cooled and/or dehumidified air) from the vehicle HVAC system 18 and directs the conditioned air into the conduit 12.

The conduit 12 extends from the HVAC system 18 to a location under the base 20 of the vehicle seat 22. In doing this, at least a portion of the conduit 12 may preferably extend through the center console 24 of the vehicle 1. Connected in fluid communication with the discharge end 16 of the conduit 12 is an outlet 26, also located beneath the base 20 of the seat 22. The conduit 12 thus transfers conditioned air from the HVAC system 18 to the outlet 26, where the conditioned air may be discharged from the outlet 26 under the base 20 of the seat 22.

The outlet 26 is configured such that the air discharged therefrom will flow out from under the base 20 of the seat 22, generally along the sides of the base 20. It is preferred that the conditioned air is discharged at a relatively low velocity, such that the conditioned air will flow out and upward from under the base 20 of the vehicle seat, 22 and follow the contour of the body of the occupant of the seat 22, in other words, having a Coand\check{a} effect on the occupant's body.

Various features could optionally be added, in singular or combination, to help direct the flow of conditioned air upward along the sides of the seat 22, from beneath the seat 22. In one example, the outlet 26 could be facing in a sideward direction. In another example, the base 20 of the seat 22 could have a deflector hanging downward from its rear side to block, the conditioned air from flowing outward from the rear of the seat 22. In yet another example, the base 20 of the seat 22 could have contours to help direct thee flow of conditioned air toward, the sides of the seat 22.

In some embodiments, the base 20 of the seat 22 may be porous, or made of a temperature conducting material, so that the conditioned air being discharged from the outlet 26 under the base 20 of then seat 22 has an additional effect of providing thermal conditioning to an occupant's thighs and buttocks through the base 20 of the seat 22.

While not required, the system 10 preferably includes an air extraction vent 28 to release or extract air from the cabin interior of the vehicle 11. When installed for use with front seats 22 of a vehicle 11, the extraction vent 28 may be located in a B-pillar 29 of the vehicle 11, or it may be located in any other suitable location, such as on the rear package tray 13 at the rear of vehicle 11. The air extraction vent 28 increases the temperature conditioning effect along an occupant's body by generally drawing air upward and out of the vehicle, creating more circulation of the conditioned air that is local to the occupant. In the alternative, in an air recirculation mode, the air extraction vent 28 may draw air out of the interior cabin to be recirculated to the vehicle HVAC system 18.

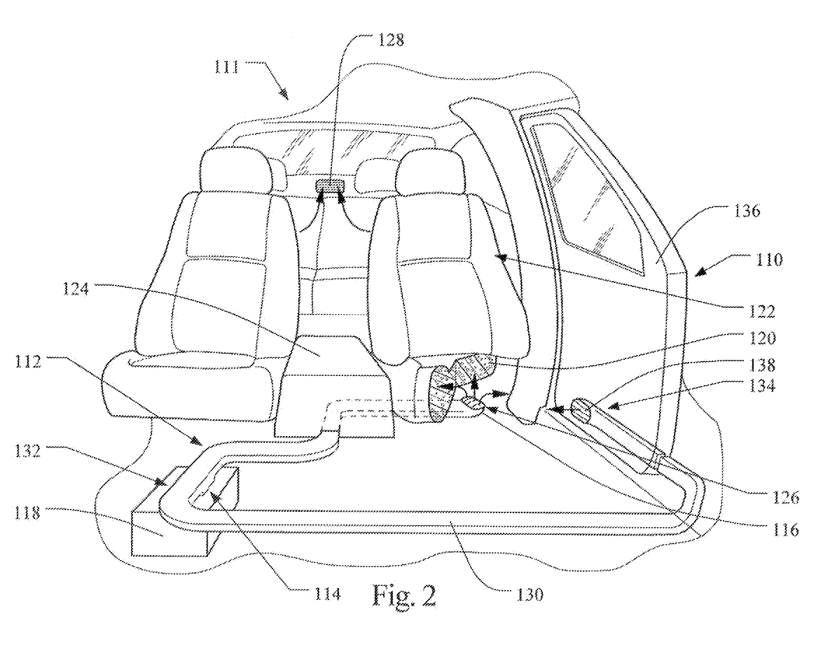

With reference to FIG. 2, another air distribution system is shown installed in a vehicle 111 and is generally designated at 110. Like the air distribution system 10 of FIG. 1, the air distribution system 110 of FIG. 2 has a conduit 112 having an intake end 114, and a discharge end 116, and an outlet 126 in fluid communication with the discharge end 116. Also, a portion of the conduit 112 may extend through the center console 124 and under the base portion 120 of the seat 122. The conduit 112 transfers conditioned air from the HVAC system 118 to the outlet 126, where the conditioned air is discharged under the base 120 of the seat 122 such that the air discharged therefrom flows out from under the base 120 of the seat 122, upward and along sides of the seat base 120.

In addition to the conduit 112 that discharges conditioned air under the base 120 of the seat 122, a second conduit 130 directs additional conditioned air to be discharged under the base 120, of the seat 122. Likewise, the second conduit 130 has an intake end 132 and a discharge end 134. The intake end 132 of the second conduit 130 may be common with the intake end 114 of the first conduit 112 or it may be a completely separate intake end 132.

The second conduit 130 extends at least partially through a door 136 of the vehicle 111 and includes an outlet 138 in fluid, communication with the discharge end 134. The outlet 138 discharges conditioned air from the door 136, as shown. In the alternative another conduit (not shown) could mate with the discharge end 134 of the second conduit 130, which would provide the outlet, 138 in a location more centered under the base 120 than when the outlet 138 is provided as merely part of the door 136. The outlet 138 discharges conditioned air generally beneath the base 120 of the seat 122, such that the conditioned air flows out from the sides of the base 120, similarly to the discharging of air from the conduit 112.

As with the prior embodiment, the air distribution system 110 also preferably has an air extraction vent 128, to direct air out of the cabin, interior of the vehicle and improve circulation and conditioning of an occupant's body.

Now with reference to FIG. 38, another air distribution system, shown installed in a passenger compartment of motor vehicle 211, is illustrated and generally designated at 210. Like the air distribution systems 10, 110 of FIGS. 1 and 2, the air distribution system 210 includes a conduit 212 that extend's to an outlet 226 that discharges conditioned air under a base portion 220 of a seat 222. In addition to, or instead of, the outlet 226, the conduit 212 is also provided with a side outlet 240 located next to a right side of the seat 222. In other words, the side outlet 240 is generally located between the side of the vehicle seat 222 and the center console 224. Thus, this side outlet 240 directs conditioned air upward along an occupant's body.

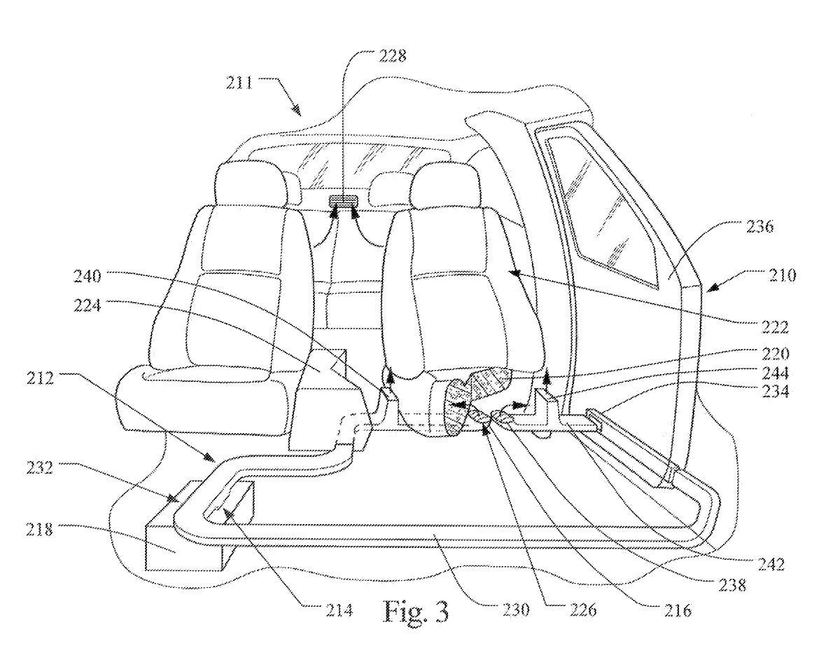

Like the air distribution system 110 of FIG. 2, the air distribution system 210 of FIG. 3 has a second conduit 230 that extends at least partially through the door 236 of the motor vehicle 211, and includes an intake end 232 and a discharge end 234. In this embodiment a third conduit 242, located mostly under the base 220 of the seat 222, mates with the discharge end 234 of the second conduit 230. The third conduit 242 may have one or both of the following outlets: an outlet 238 located under the base 220 of the vehicle seat and/or an outlet 244 located along the side of the base 220 of the vehicle seat 222 between the door 236 and side of the vehicle seat 222. The outlet 238 located under the base 220 of the vehicle seat discharges conditioned air under the base 220 of the seat 222 such that the air flows out from the sides of the base 220, upward along the sides of an occupant's body. The side outlet 244 is oriented to specifically direct conditioned air upward along the sides of an occupant's body.

The air distribution system 210 also preferably has an air extraction vent 228, to direct air out of the cabin interior of the, vehicle 211. As previously described, the air extraction vent 228 will improve circulation and conditioning of an occupant's body by drawing the air in the passenger compartment out of the cabin interior of the vehicle 211.

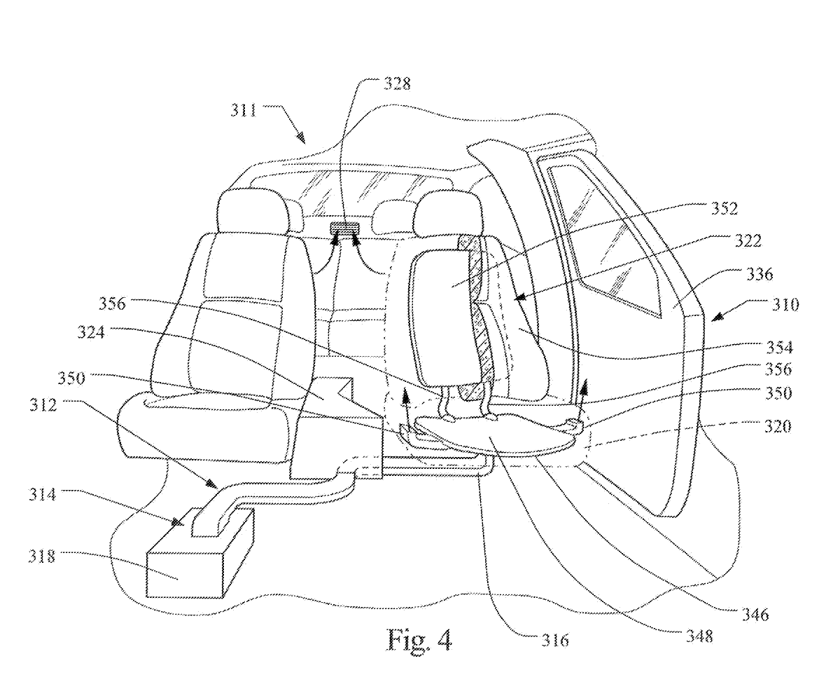

Another air distribution system is illustrated and designated generally at 310 in FIG. 4. Shown installed in a motor vehicle 311, the system 310 includes a conduit 312 having an intake end 314 and a discharge end 316. The intake end 314 is in fluid communication with a vehicle HVAC system, schematically illustrated at 318.

The conduit 312 transfers conditioned air from the vehicle HVAC system 318, preferably through the center console 324 of the vehicle 311, and discharges at least some of the conditioned air via a plenum 346 located beneath the vehicle seat 322. The fact that the, plenum 346 is located beneath the seat 322 shall be taken to mean that the plenum 346 may be located either under the base 320 or merely under a top layer of the base 320. In other words, the plenum 346 may be incorporated into the base 320 such that only a top layer of the base 320 is located above the plenum 346. In some embodiments, the plenum 320 may be integrally formed with the base 320 such that the base 320 provides a top side 348 of the plenum 346. In such embodiments, the plenum 346 is still considered to be beneath the vehicle seat 822 because, a top layer of the base 320 is located above the plenum 346.

The plenum 346 conducts conditioned air, via the plenum 346, through the base 320 of the seat 322 so as to provide thermal conditioning through the base 320 to an occupant's thighs and buttocks. Alternatively, the base 320 or plenum 346 could have pores (not shown) to direct conditioned air through the base 320 and provide thermal conditioning for an occupant's thighs and buttocks.

A second plenum 352 may be optionally provided in the back 354 of the seat 322. When provided as such, the second plenum 352 is connected to the first plenum 346 with conduits 356, which distribute the conditioned air into the second plenum 352. The, second plenum 352 provides thermal conditioning to an occupant's back through the back 354 of the vehicle seat 322. The second plenum 352 may provide thermal conditioning by conduction through the seat back 354 or by releasing conditioned air through pores (not shown) in the seat back 354, or by any other suitable method.

Two side outlets 350 are additionally provided in fluid communication with the conduit 312, with one side outlet 350 being located between the base 320 and the center console 324, and another side outlet 350 being located between the base 320 and the door 336. In the alternative, merely one side outlet 350 could be provided, or more than two side outlets 350 could be provided. The side outlets 350 are oriented to direct conditioned air upward along an occupant's sides. Preferably, the conditioned air is released at a relatively low velocity to allow the air to follow the contours of the occupants' body, thereby providing effective thermal conditioning to an occupant's body. Releasing the conditioned air at a low velocity may also have the benefit of requiring less power for operation and making less noise than a conventional climate control system.

The air distribution system 310 also preferably has an air extraction vent 328 to extract air from the cabin interior of the vehicle 311 and provide better circulation and better thermal conditioning to occupants thereof.

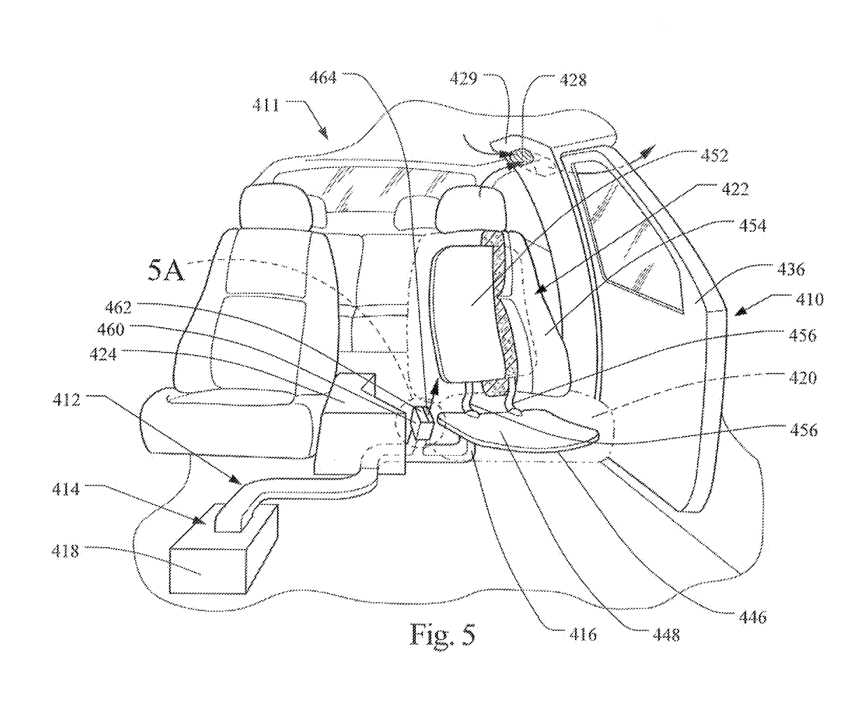

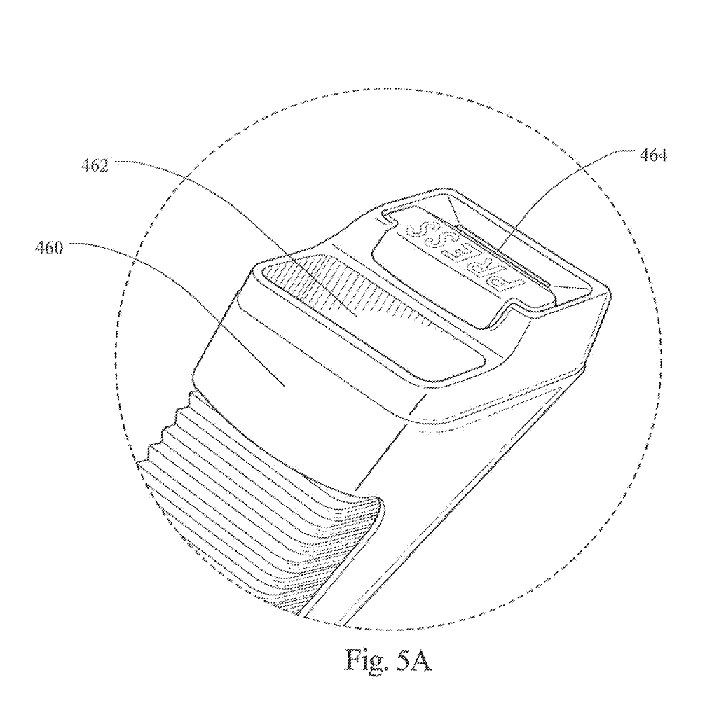

Now with, reference to FIG. 5, a further air distribution system is illustrated, installed within a vehicle 411, and generally designated at 410. The air distribution system 410 of FIG. 5 is identical to the air distribution system 310 of FIG. 4, except that it lacks the side outlets 350 from the plenum 346 and includes a seat belt anchor outlet 462, which will be described in further detail below. Thus, the system 410 has a conduit 412 that transfers conditioned air from a vehicle HVAC system 418 to a plenum 446 located beneath a vehicle seat 422. To this end, the conduit 412 has an intake end 414 in fluid communication With the HVAC system 418 and a discharge end 416 in fluid communication with the plenum 446.

Like the plenum 346 of FIG. 4, the plenum 446 of FIG. 5 is located beneath the vehicle seat 422 and may be incorporated with the base 420 of the vehicle seat 422, as described with reference to FIG. 4. The plenum 446 provides thermal conditioning to an occupant through the base 420 of the vehicle seat 422, either by conduction through the base 420 or through pores (not shown) or both. Further, the air distribution system 410 may be provided with a second plenum 452, which is connected to the plenum 446 through conduits 456. The second plenum 452 may be configured to provide thermal conditioning to an occupant's back side through the back, 454 of the vehicle seat 422, by virtue of conduction through the seat back 454, or through pores (not shown), or both.

With reference to FIGS. 5-5A, the conduit 412 is connected to a lower seat belt anchor 460. More specifically, the conduit 412 is in fluid communication with a seat belt anchor outlet 462, which is located next to the seat belt latching mechanism 464 and incorporated with the seat belt anchor 460. Thus, the conduit 412 transfers conditioned air from the vehicle HVAC system 418 to the seat belt anchor outlet 462. Preferably, the seat belt anchor outlet 462 is located on the outer side of the seat belt latching mechanism 464. With this configuration, the seat belt anchor outlet 462 discharges conditioned air, and the conditioned air travels generally along the seat belt (not shown), to move the air across an occupant's torso. The conditioned air is preferably discharged at a relatively low velocity so that the conditioned air may follow the seat belt line contour; in other words, the temperature conditioned air may condition the occupant's body through travel along an occupant's body with a Coand\check{a} effect.

In the alternative, the plenum 446 could be omitted, and the conduit 412 could provide conditioned air only to a seat belt anchor outlet 462.

The air distribution system 410 also preferably has an air extraction vent 428 to extract air from the cabin interior of the vehicle 411 and provide better circulation and better thermal conditioning to occupants. Preferably, the air extraction vent 428 is located in a B-pillar 429 of the Vehicle 411, particularly when the system 410 is installed for use with front seats 422 of the vehicle 411.

As a person skilled in the art will readily appreciate, the above descriptions is meant as an illustration of implementation of the principles this invention. This description is not intended to limit the scope or application of this invention in that the inventions is susceptible to modification, variation and change, without departing from the spirit of this invention, as defined in the following claims.

I claim:

1. An air distribution system for use in a passenger compartment of a motor vehicle having an HVAC system, the air distribution system comprising a conduit having an intake end and a discharge end, the intake end being configured for fluid communication with the HVAC system;
an outlet in fluid communication with the discharge end of the conduit, the outlet configured to be located under a vehicle seat;
the conduit being configured to transfer conditioned air from the HVAC system to the outlet, and the outlet being configured to discharge the conditioned air under the vehicle seat so as to allow the conditioned air to flow out from under the vehicle seat and up along a side of the vehicle seat.

2. The air distribution system of claim 1, wherein at least a portion of the conduit is located within a center console, the center console being configured to be installed in a vehicle.

3. The air distribution system of claim 1, the vehicle seat is provided having a base portion configured to pass conditioned air from the outlet through the base portion of the vehicle seat and to an occupant.

4. The air distribution system of claim 1, further comprising a door conduit having an intake end and a discharge end, the intake end being in fluid communication with the HVAC system, at least a portion of the door conduit being configured to be located within a door of the vehicle, the door conduit being configured to direct conditioned air from the HVAC system to an area under the vehicle seat.

5. The air distribution system of claim 4, wherein the conduit and the door conduit each have a second outlet, the second outlets being upward-facing and configured to release conditioned air upward at a side of the vehicle seat.

6. The air distribution system of claim 1, further comprising an air extraction vent configured to extract air from the cabin interior of the vehicle.

7. The air distribution system of claim 1, further comprising means for directing conditioned air to flow out from under the vehicle seat and up along a side of the vehicle seat.

8. The air distribution system of claim 1, further comprising a plenum in fluid communication with the conduit and the outlet, the plenum being located beneath the vehicle seat.

9. The air distribution system of claim 1, further comprising a lower seat belt anchor associated with the seat, the lower seat belt anchor defining a seat belt anchor outlet, the seat belt anchor outlet being in fluid communication with the discharge end of the conduit, the, seat belt anchor outlet being configured to direct the conditioned air upward.

10. An air distribution system in a passenger compartment of a motor vehicle having a seat, the system comprising:
a conduit having an intake end and a discharge end, the intake end being in fluid communication with a vehicle HVAC system, the conduit being configured to transfer conditioned air from the HVAC system to the passenger compartment;
a plenum fluidly coupled to the discharge end of the conduit, the plenum being located beneath the vehicle seat;
at least one outlet in fluid communication with the plenum, the outlet oriented to direct the conditioned, air upward from the plenum along a side of the vehicle seat.

11. The air distribution system of claim 10, wherein the at least one outlet comprises two outlets, each of the two outlets being located on opposite sides of the vehicle seat.

12. The air distribution system of claim 10, wherein the vehicle seat has a seat base, the seat base has a bottom side, the plenum being incorporated into the vehicle seat such that the bottom side of the seat base defines a top side of the plenum.

13. The air distribution system of claim 10, wherein the vehicle seat has a seat base configured to permit conditioned air to pass from the plenum through the seat base and to a seating surface of the seat base.

14. The air distribution system of claim 10, further comprising an upper plenum located in a seat back of the vehicle seat, the upper plenum being in fluid communication with the plenum.

15. The air distribution system of claim 14, wherein the seat back is configured to allow conditioned air from the upper plenum to pass through the seat back to a seating surface of the seat back.

16. An air distribution system for use in a passenger compartment of a motor vehicle having a seat, the system comprising:
a conduit having an intake end and a discharge end, the intake end being in fluid communication with a vehicle HVAC system, the conduit transferring conditioned air from the vehicle HVAC system to the passenger compartment;
a lower seat belt anchor associated with the seat, the lower seat belt anchor defining an outlet connected to the discharge end of the conduit, the outlet being configured to direct the temperature conditioned air upward.

17. The air distribution system of claim 16, wherein at least a portion of the conduit is located within a center console within the passenger compartment.

18. The air distribution system of claim 16, further comprising a plenum located beneath a vehicle seat, the plenum being in fluid communication with the conduit.

19. The air distribution system of claim 18, wherein the vehicle seat has a seat base coupled to the plenum, the seat base having portions configured to allow conditioned air within the plenum to provide thermal conditioning through the seat base to a seating surface of the vehicle seat.

20. The air distribution system of claim 18, further comprising an upper plenum located in a seat back of the vehicle seat, the upper plenum being in fluid communication with the plenum, the seat back having portions configured to allow conditioned air within the upper plenum to provide thermal conditioning through the seat back to a seating surface of the vehicle seat.
